(19) United States
(12) Patent Application Publication
(10) Pub. No.: US 2026/0320126 A1
(43) Pub. Date: Oct. 15, 2026

(54) Systems and Methods for AI-Driven Construction and Configuration of Transformation-Journey Models

(71) Applicant: KPMG International Services Ltd, London (GB)

(72) Inventors: Christopher LaForge, New York, NY (US); Aaron Saunders, Belfast (IE); Natasha Moore, London (GB)

(73) Assignee: KPMG International Services Ltd, London, EA (GB)

(21) Appl. No.: 19/537,113

(22) Filed: Feb. 11, 2026

Related U.S. Application Data
(60) Provisional application No. 63/757,014, filed on Feb. 11, 2025.

(51) Int. Cl. G06F 16/901; G06F 16/22

(52) U.S. Cl. CPC G06F 16/9024; G06F 16/22

(57) ABSTRACT

Systems and methods for configuring a transformation-planning platform includes storing, in non-transitory memory, a journey data structure made of interconnected nodes representing elements of a transformation program. The method receives client data through a network interface and analyzes it using an AI model or rules engine to select an appropriate subset of phases from a predefined set. The system updates the journey data structure to include elements corresponding to the selected phases and assigns phase entry and exit criteria. It maps the transformation journey across enterprise, functional, and foundational layers by creating edges linking organizational aspects to journey elements. The method further selects relevant enablers by comparing multi-dimensional enabler metadata with the client data and the current journey structure, adding selected enablers into the graph. A WBS generator then traverses the updated structure to produce a WBS table, and the system exports a journey package containing the journey representation and generated WBS output.

### CROSS-REFERENCE TO RELATED APPLICATIONS

This application claims the benefit of U.S. Provisional Application No. 63/757,014 filed Feb. 11, 2025, which is incorporated herein in its entirety.

### BACKGROUND OF THE INVENTION

Organizations undertaking complex business transformations-whether implementing new technology platforms, redesigning operating models, or restructuring processes across enterprise, functional, and foundational layers-face increasing difficulty in planning, structuring, and executing such engagements with precision, consistency, and clarity. Historically, consulting teams have relied heavily on manually created plans, ad hoc work breakdown structures, disparate repositories of content, and subjective practitioner judgment to determine transformation phases, tasks, deliverables, and resource needs. These traditional approaches have led to significant fragmentation, inefficiency, and inconsistency across engagements, particularly when transformation programs must be tailored to the unique characteristics of each client's strategy, industry, functional landscape, and technological posture. As enterprise environments grow in volume, diversity, and velocity, consulting teams struggle not merely with the magnitude of content and data, but with the complexity of determining which transformation activities apply, how they interrelate, and in what sequence they should be executed.

Prior attempts to address these difficulties have largely focused on static templates, manual expert-driven frameworks, or isolated automation utilities. Many consulting organizations introduced reusable slide decks, proposal templates, playbooks, maturity models, or preconfigured work breakdown structure (WBS) spreadsheets intended to accelerate engagement planning. Although such resources provide a starting point, they lack a technical mechanism for dynamically adapting to specific client conditions. These tools cannot algorithmically interpret client data, assess readiness across transformation phases, or map transformation activities across enterprise layers. As a result, practitioners are forced to manually interpret the templates, restructure content for each engagement, and identify applicable enablers or accelerators based on personal memory or narrow search queries. This manual adaptation process is error-prone, time-consuming, and fails to scale, particularly for multidimensional engagements where hundreds of tasks, deliverables, and dependencies must be consistently structured.

Other attempts have relied on conventional project-management software, which may allow the creation of task hierarchies or dependencies but lack semantic awareness of transformation phases, organizational layers, or enabler applicability. These platforms cannot automatically build a transformation journey from client data, recompute readiness-based phase selection, or maintain a consistent mapping between enterprise-level outcomes, functional workstreams, and foundational technical enablers. They are not built to ingest multi-layer metadata or to perform intelligent selection of enablers based on multi-dimensional relevance factors. Because these systems treat tasks as generic list entries without conceptual understanding of transformation structures, they cannot furnish a coherent or data-driven engagement design.

Some organizations attempted to mitigate these limitations by building isolated knowledge repositories or document-search systems. While such systems could index content, they lacked the context-aware retrieval capabilities needed for effective transformation planning. Traditional search systems do not understand which phase, outcome, or task the practitioner is attempting to define; they return documents based on keyword relevance alone, which often yields large, unfocused sets of results. They do not associate content with graph structures representing transformation journeys, nor can they produce ranked results based on the structural position of a given task or phase within the journey. This resulted in practitioners spending extensive time browsing through content libraries, interpreting materials case-by-case, and manually stitching together heterogeneous artifacts.

Still other efforts involved the use of static transformation frameworks or proprietary methodologies, often confined to human-readable diagrams or multi-page PDFs. While such frameworks can describe logical sequences of transformation phases or conceptual relationships among organizational layers, they do not include any computational mechanism to operationalize those frameworks. They cannot compute readiness scores, revise the transformation plan based on user modifications, dynamically adjust cross-layer mappings, or perform real-time propagation of changes across interconnected tasks and deliverables. This inability to operationalize high-level frameworks prevents the automated generation of consistent and accurate outputs such as WBS and tailored engagement plans.

Furthermore, even in organizations experimenting with artificial intelligence tools-such as chat-based assistants or recommendation engines-the solutions tend to be narrow and disconnected. These early attempts did not combine AI-driven analysis of client data with structured graph-based representations of transformation journeys. They lacked the architectural integration required to link AI-driven phase selection, cross-layer mapping, enabler relevance scoring, content indexing, and WBS generation into a unified end-to-end system. Instead, AI use cases were often superficial, producing explanatory text without the structural fidelity or reusability needed to support execution-grade consulting artifacts.

As a result of these fragmented and incomplete efforts, consulting practitioners continue to face several persistent technical challenges. They lack a system that can ingest client data and automatically instantiate a transformation journey represented as a machine-readable graph. They lack automated determination of which transformation phases should be activated based on readiness assessments. They lack a mechanism for systematically mapping journey elements across enterprise, functional, and foundational layers. They lack algorithmic selection of enablers based on multi-dimensional metadata and the ability to integrate those enablers into the journey representation in real time. They lack unified content-schema normalization and context-aware search that retrieves content items associated with specific journey nodes. And they lack an automated approach for generating complete, accurate, and machine-readable WBS derived directly from the transformation journey.

### SUMMARY OF THE INVENTION

Although illustrative embodiments of one or more aspects are provided herein, the disclosed processes may be implemented using any number of techniques. The disclosure is not limited to the illustrative or specific embodiments, any drawings, and any techniques illustrated herein, including any exemplary designs and embodiments illustrated and described herein, and may be modified within the scope of the appended claims along with their full scope of equivalents.

In one aspect, a system is a computer-implemented transformation-planning platform for consulting engagements that uses one or more processors and a non-transitory memory to execute specialized components built around a journey data structure. The journey data structure is a graph of nodes and edges representing elements of a transformation journey and their dependencies. A journey generation engine analyzes client data with an AI model or rules engine to construct an initial journey in this graph, while a cross-layer proposition mapping engine adds edges that represent relationships among different organizational aspects. A phase recommendation engine computes readiness scores for predefined phases (strategize, architect, orchestrate, mobilize, deliver, and run), adjusts the journey to include only phases whose scores meet a threshold, and generates phase-specific entry and exit criteria. The system also maintains an enabler library and uses an enabler selection engine to embed relevant enablers into the graph, normalizes content via a unified content schema for indexing in a multi-modal search index, and employs a WBS generator to traverse the graph and output a machine-readable WBS table.

In another aspect, a computer-implemented method configures a transformation-planning platform by storing a graph-based journey data structure in memory, receiving client data through a network interface, and analyzing that data with an AI model or rules engine to determine which transformation phases-such as strategize, architect, orchestrate, mobilize, deliver, and run-should be included. The system updates the journey structure to reflect the selected phases and their entry and exit criteria, maps journey elements across enterprise, functional, and foundational layers, and identifies relevant enablers by comparing enabler metadata with the client data and the current journey configuration. It then embeds the selected enablers into the graph and uses a WBS generator to traverse the updated structure and create a work-breakdown-structure table containing task rows and fields for phase, organizational aspect, resource role, and timing. Finally, the method exports a journey package that includes both the journey representation and the generated WBS.

In another aspect, a non-transitory computer-readable storage medium containing instructions that enable a consulting-engagement platform to ingest client and configuration data, maintain a graph-based journey data structure representing transformation-journey elements and their dependencies, and normalize heterogeneous content from multiple repositories using a unified content schema. The instructions further cause the platform to build and maintain a multi-modal search index over these normalized content records, associate each record with specific journey nodes based on fields such as phase, outcome, task identifier, or enabler identifier, and process search queries that include a journey context identifying at least one node in the graph. In response, the platform returns ranked search results drawn from the search index, where the results correspond to normalized content linked to nodes related to the identified journey node, thereby enabling context-aware, structurally informed retrieval of transformation-planning content.

### BRIEF DESCRIPTION OF DRAWINGS

The present invention is described by way of example and not limited to the accompanying figures in which like reference numbers indicate similar elements.

FIG. 1 is a diagram illustrating a transformation-planning platform.

FIG. 2 illustrates a method-level flow of operations performed by the transformation-planning platform of FIG. 1.

FIG. 3 illustrates a computer hardware device and suitable networked computing environment for implementing the platform of FIG. 1 and executing the computer-implemented method of FIG. 2.

### DETAILED DESCRIPTION OF THE INVENTION

Modern enterprises increasingly depend on large-scale transformation initiatives that span multiple business domains, technology platforms, organizational layers, and functional workstreams. These transformations, whether driven by digital modernization, regulatory change, market pressure, or the adoption of cloud, AI, or ERP platforms, require an extraordinary degree of planning precision, content orchestration, dependency modeling, and execution coordination. Yet the current state of technology available to consulting practitioners is fundamentally inadequate for addressing the inherent complexity and dynamism of these engagements. This inadequacy forms the core technical problem that the present invention solves.

The first dimension of the technical problem arises from the inability of existing systems to transform heterogeneous client input into a structured, machine-readable and machine-modifiable transformation plan. In current practice, client needs are captured through free-form questionnaires, interviews, slide materials, or spreadsheets. Because this information is unstructured and highly variable, no conventional system can algorithmically interpret it to determine which phases of a transformation should be executed, what outcomes are relevant, what deliverables must be produced, or what tasks should be sequenced. Existing software tools lack mechanisms for automatically translating variable client data into a coherent, graph-based representation of a transformation journey. Instead, practitioners manually evaluate client responses, map them to preconceived frameworks, and construct project plans from scratch. This dependence on manual interpretation creates substantial risks of inconsistency, incompleteness, and human error, particularly as engagements scale in size and complexity.

A second, deeper technical problem is the absence of systems capable of computing phase readiness, selecting applicable transformation phases, and generating phase-specific entry and exit criteria in real time. Traditional consulting methodologies rely on static frameworks that explain what transformation phases in theory exist, but no existing system is capable of computing which phases apply to a specific client scenario based on multi-dimensional client characteristics. Phase selection today is a subjective, non-algorithmic process handled manually by senior practitioners. As a result, transformation roadmaps are prone to both over-scoping and under-scoping, neither of which can be corrected systematically because no software artifact models readiness quantitatively or adjusts recommended phases automatically.

A third major technical obstacle is the lack of any computational mechanism or data structure capable of representing transformation journeys in a way that preserves both top-down (phases and outcomes) and cross-layer (enterprise, function, foundation) dependencies. Existing project-management software tools can store lists of tasks or hierarchical breakdowns, but they lack the ability to encode multi-layered transformation logic. They cannot represent the interconnectedness between enterprise-level objectives, functional transformations, and foundational technology efforts. They likewise cannot update one layer when another changes. This limitation becomes catastrophic in transformation programs, where architectural decisions in the foundational layer dictate changes in functional tasks, which in turn affect enterprise-wide outcomes. Without a graph-based representation that encodes these dependencies, any change to the transformation design requires manual reconciliation across multiple documents, spreadsheets, and workstreams, leading to fragmentation, misalignment, and lost information fidelity.

The fourth technical deficiency in existing systems involves the inability to algorithmically identify, evaluate, and select enablers-templates, accelerators, code modules, or tools-based on multi-dimensional relevance criteria. Most organizations maintain large repositories of such enablers, but because these repositories are disorganized and lack normalized metadata, recommending relevant enablers is effectively impossible. Practitioners search manually through shared drives and content repositories, relying on personal experience or tribal knowledge. There is no centralized or computational framework that analyzes client data, matches it against enabler metadata, computes relevance scores, and integrates the selected enablers directly into the transformation plan.

Another related technical problem arises from the fragmentation of content across heterogeneous repositories, including slide decks, spreadsheets, documents, templates, tooling libraries, and knowledge bases. Traditional enterprise search systems, whether keyword-based or tag-based, cannot understand the structural position of a task or phase within a transformation journey and therefore cannot retrieve content contextually. This leads to an enormous content-retrieval burden: practitioners spend large amounts of time locating and re-creating materials instead of generating client-specific insights. No existing system normalizes content using a unified content schema, indexes it in a multi-modal search index, and associates each content record with specific nodes in a journey graph.

A further technical shortfall in the state of the art is the lack of automated generation of work breakdown structures (WBS) from transformation-journey data. Because existing systems cannot represent transformation phases, outcomes, deliverables, tasks, dependencies, and cross-layer relationships in a structured manner, they likewise cannot compute a machine-readable WBS. Instead, project teams manually construct WBS spreadsheets, often copying and pasting from templates, which results in inconsistent formatting, inaccurate relationships, and misaligned dependencies. These manually created artifacts become quickly outdated and must be maintained separately from the conceptual transformation plan, producing version-control issues and unnecessary rework.

Compounding these challenges is the absence of dynamic, real-time reactivity. Under conventional tooling, when practitioners modify phases, tasks, or enablers, the resulting changes do not automatically propagate through the transformation plan, nor do related outputs such as the WBS update automatically. This lack of synchronicity forces teams to manually reconcile documents and update downstream artifacts, further amplifying the risk of inconsistencies.

Finally, practitioners lack a technically coherent system that unifies all of these operations—data ingestion, journey construction, phase readiness, cross-layer mapping, enabler selection, content normalization, context-aware search, and WBS generation—into a single end-to-end, computer-implemented platform. Instead, they rely on a patchwork of unintegrated tools, none of which provides the computational mechanisms needed to produce accurate, consistent, scalable, and reusable transformation journeys.

The invention described in this application directly addresses these long-standing and unresolved technical problems. It introduces a structured journey data structure, a suite of specialized engines, a unified schema for content normalization, a multi-modal search index, and a fully automated WBS generator—all operating over processor-executed instructions stored in computer memory—to create a technically sophisticated, internally consistent, and dynamically updatable system for planning and executing consulting transformations. By solving each of the deficiencies described above, the invention fundamentally transforms how complex transformation engagements are computed, represented, updated, and operationalized in modern consulting environments.

The invention solves the longstanding technical problems associated with planning, structuring, and operationalizing complex transformation engagements by introducing a computer-implemented platform that unifies client-data ingestion, graph-based journey construction, phase readiness computation, cross-layer mapping, enabler relevance scoring, content normalization, context-aware retrieval, and automated WBS generation into a single coherent system. It does so through a suite of specialized software engines executed on one or more processors, operating over structured data elements stored in computer memory, all arranged around a core journey data structure that dynamically encodes the full architecture of a transformation program. Instead of relying on static templates, manual interpretation, siloed content repositories, and isolated project-management tools, the invention creates a computational substrate capable of receiving heterogeneous client inputs and converting them into a machine-readable, machine-modifiable transformation journey. The journey data structure serves as the central technical mechanism: a graph of nodes and edges that supports real-time updates, dependency propagation, metadata association, and automated output generation. This structure—far richer than any document-based framework or hierarchical task list—provides the technical foundation necessary to represent multi-phase, multi-layer, multi-deliverable transformations with precision and consistency.

A key aspect of the solution is the invention's ability to algorithmically interpret client data using an AI model or rules engine to determine which transformation phases apply and how those phases should be ordered and parameterized. By computing readiness scores for each predefined phase and activating only those that satisfy a threshold, the invention transforms historically subjective, practitioner-driven decisions into formalized, repeatable, computational operations. Through this mechanism, the system resolves the technical problem that existing tools cannot dynamically adapt transformation frameworks to client-specific conditions. The journey generation engine and phase recommendation engine work in tandem to update the journey data structure in real time, ensuring that the transformation plan emerging from the system accurately reflects the client's readiness and constraints at the time of evaluation.

The invention further solves the technical problem of representing the cross-layer nature of transformation engagements—something entirely unachievable with conventional project-management platforms—through the cross-layer proposition mapping engine. By generating edges between transformation-journey nodes and nodes representing organizational layers, the invention ensures that changes to any transformation element cascade appropriately to dependent elements. This ability to enact automated, structure-preserving propagation of changes directly addresses the technical deficiency that previously required practitioners to reconcile multiple documents manually. The system's formal graph representation, coupled with engines capable of updating edges and dependencies, enforces structural integrity and maintains alignment across enterprise, functional, and foundational layers.

Another dimension of the solution lies in the invention's sophisticated enabler selection engine, which evaluates multi-dimensional metadata associated with each enabler and computes relevance scores that determine which enablers should be recommended and inserted into the journey structure. This capability directly solves the technical problem that content and accelerators exist in disparate locations without any means of computational relevance assessment. By embedding selected enablers directly into the graph representation, the invention ensures that accelerators, templates, code modules, and tools are not merely retrieved but structurally integrated into the transformation plan. This integration was impossible under prior art, which lacked both a structured journey model and an algorithmic mechanism for matching enablers to client-based criteria.

The invention also addresses the problem of inconsistent and incomplete content retrieval through its unified content schema and multi-modal search index. By normalizing content from heterogeneous sources into structured records, and associating those records with nodes in the journey data structure, the invention enables fully contextualized search retrieval. Unlike traditional search engines that rely solely on keywords, the multi-modal search index retrieves content based directly on the system's understanding of the transformation journey and its structural position within that journey. This solves the technical problem of practitioners being forced to browse through repositories without structural guidance, resulting in fragmented knowledge use and duplicated effort.

Finally, the invention solves the technically complex and previously unaddressed problem of generating a complete, accurate, and machine-readable work breakdown structure (WBS) based solely on the journey data structure. The WBS generator traverses nodes representing tasks, reads associated metadata for phases, organizational aspects, resource roles, and timing, and produces a structured WBS table in a consistent format that can be exported programmatically. This automated generation ensures that the WBS always aligns with the current journey structure, eliminating version-control errors and significantly reducing manual work. The ability to propagate updates through the graph and regenerate the WBS in real time is a substantial technical improvement over existing tools that treat WBS files as static artifacts.

The invention provides numerous technical benefits arising directly from the system's architecture and the way it solves the technical problems outlined above.

Because the invention is built around a structured journey data structure, it ensures that transformation journeys are internally consistent, structurally valid, and machine-tractable. This graph-based representation allows the system to compute dependencies, propagate changes, and maintain cross-layer alignment in a manner wholly unavailable in prior systems. As a result, practitioners receive dynamically updated, technically coherent transformation plans that remain accurate throughout the engagement lifecycle.

Another major benefit is the dramatic reduction in manual interpretation, adjustment, and reconciliation, which improves both the accuracy and reliability of transformation planning. The automation of phase selection through readiness scoring provides a rigor and reproducibility not achievable through subjective human judgment. This results in engagement designs that are more tailored, more defensible, and more aligned with actual client conditions. Furthermore, the system enables consistent reuse of transformation patterns and historical journey structures, which significantly enhances efficiency and standardization across consulting teams.

The integration of multi-dimensional enabler metadata with algorithmic relevance scoring provides a benefit that is entirely new to the field: the ability to computationally select and embed enablers into the transformation plan. This eliminates the reliance on human recollection and ad hoc content browsing, ensuring that each engagement benefits from the most relevant accelerators and best practices available. The invention thus serves as a technical bridge between the organization's collective knowledge base and the specific needs of each engagement, driving higher quality and more predictable delivery outcomes.

The unified content schema and multi-modal search index confer their own substantial benefits. By normalizing content and linking it directly to journey nodes, the system enables practitioners to retrieve content that is not only relevant in substance but appropriate in structural context. This reduces noise in search results, accelerates content discovery, and ensures that practitioners rely on materials that are specifically aligned to the task or phase they are currently designing. The result is improved content consistency, reduced duplication, and more efficient development of client-facing deliverables.

The automated WBS generator provides yet another important benefit: the ability to produce machine-readable, execution-ready WBS structures that are always synchronized with the latest transformation design. This feature does not merely save time; it fundamentally improves the fidelity of project planning by eliminating the disconnect between conceptual transformation planning and operational execution planning. Because the WBS is generated directly from the journey data structure, and because the data structure itself updates dynamically based on practitioner inputs and system-level reasoning, the WBS remains a single source of truth that accurately reflects the entire transformation program at any given moment.

Taken together, the invention provides a deeply integrated, technically robust platform that transforms transformation planning from a manual, fragmented, error-prone set of activities into a scaled, repeatable, data-driven, and computationally verifiable process. Its combination of structural modeling, algorithmic reasoning, relevance scoring, content normalization, and automated artifact generation produces not only more efficient workflows but also superior accuracy, consistency, transparency, and adaptability. In doing so, the invention delivers capabilities fundamentally beyond those of any existing system and resolves technical challenges that have persisted in the consulting domain for decades.

In sum, the present invention represents a clear technological improvement to the functioning of a computer system. The journey-data-structure-based platform described here achieves enhancements in the domain of transformation-planning computation. By enabling a computer to construct, update, traverse, and interpret a richly structured graph of phases, tasks, outcomes, dependencies, organizational layers, and enablers (something conventional computers cannot do without substantial manual intervention) the invention allows the computer to perform operations more efficiently, more accurately, and with far less resource consumption. The invention's integrated engines, including the phase recommendation engine, cross-layer proposition mapping engine, enabler selection engine, unified content schema, and multi-modal search index, collectively transform raw client data and heterogeneous content into actionable, structurally coherent, machine-processable outputs. These components allow the computer to compute readiness scores, propagate dependencies, normalize content, perform context-aware search, and generate a complete work-breakdown structure directly from the journey graph, which are capabilities that meaningfully enhance the computer's processing efficiency and technical performance. The invention therefore does more than automate a business process. Rather, it provides a specific improvement to computer technology itself, enabling the computer to operate in a fundamentally more capable, efficient, and technically sophisticated manner.

### System Architecture

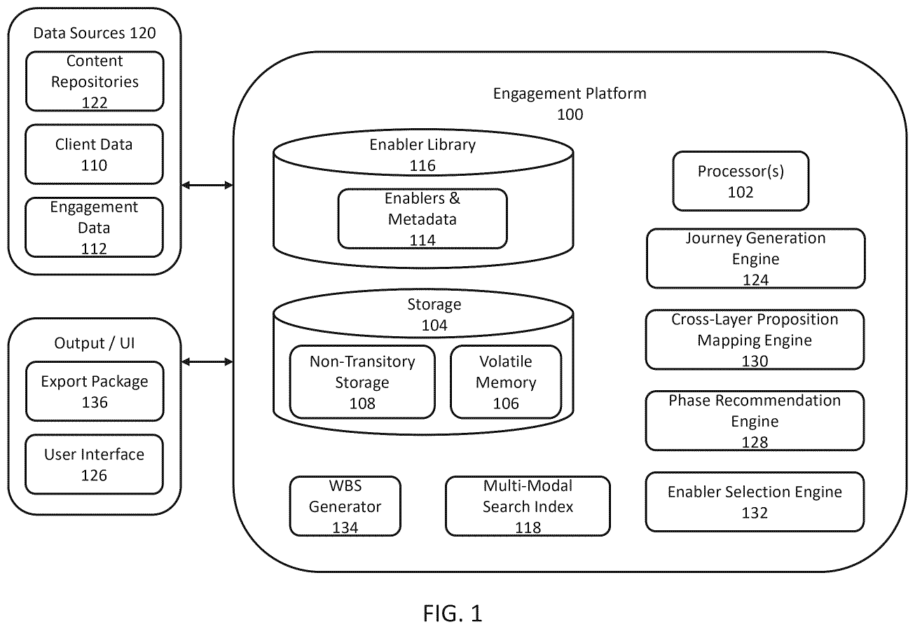

The system illustrated in FIG. 1 is implemented as a transformation-planning platform 100 executed on one or more processors 102 that coordinate data flows between multiple functional modules, internal data structures, and external data sources. The processors 102 execute instructions stored in storage 104, which includes in both volatile memory 106 and non-transitory storage 108, and collectively form the computational core of the engagement platform. Within this platform 100, a collection of engines, indexing components, and generation modules interact with structured and unstructured data sources to construct, refine, and output representations of a consulting transformation journey. These processors 102 have continuous access to volatile memory 106, which buffers real-time inputs such as client data 110 and engagement-specific information 112, and to non-transitory storage 108, which retains persistent artifacts including the journey data structure, enablers and their metadata 114 (stored in an enabler library 116), the multi-modal search index 118, and previously generated WBS.

The system receives three principal categories of input from various data sources 120: client data 110, engagement data 112, and content from content repositories 122. Client data 110 may originate from questionnaires, document uploads, system integrations, or practitioner inputs and is received into the platform 100 through a data sources interface. Engagement data 112 pertains to ongoing or historical transformation engagements and includes previously generated journeys, WBS, task outcomes, and feedback information. Content repositories 122 store heterogeneous artifacts such as pitch decks, journey guides, templates, historical WBS tables, and technical documentation. All these inputs flow into the engagement platform 100 where they are staged in volatile memory 106 for subsequent processing by the engines responsible for journey construction and analysis.

Central to the system's operation is the journey data structure, a graph-based structure stored in non-transitory memory 108 and referenced continuously by nearly every engine in the platform. The journey data structure comprises a plurality of nodes and edges representing the elements of a transformation journey and dependency relationships among those elements. The nodes may represent phases, sub-phases, outcomes, deliverables, tasks, organizational layers, and enablers; the edges encode ordering, functional dependencies, and cross-layer relationships. Although FIG. 1 depicts the journey data structure abstractly within storage elements, its construction and evolution are driven by the system modules described below.

A journey generation 124 engine is responsible for creating the initial instance of this journey data structure. Using the client data 110 staged in volatile memory 106, the engine 124 invokes an artificial intelligence model and/or a rules engine to determine which journey elements are relevant for the client engagement. This analysis may include assessing transformation triggers, strategic goals, platform requirements, functional domains, and industry sectors. Based on this evaluation, the journey generation engine 124 populates the graph with an initial set of nodes and edges, establishing relationships among phases, sub-phases, outcomes, deliverables, and tasks. The engine 124 continues to modify this structure as the system 100 receives additional client data, detects changes in engagement conditions, or receives practitioner inputs through a user interface 126.

A companion module, the phase recommendation engine 128, interacts closely with the journey generation engine 124. This engine 128 analyzes the incoming client data 110 to compute readiness scores for each of the transformation phases, including strategize, architect, orchestrate, mobilize, deliver, and run. Based on these scores, the phase recommendation engine 128 determines which phases should be included or excluded from the transformation journey. It then instructs the journey generation engine 124 to adjust the journey data structure accordingly, ensuring that only nodes associated with readiness-qualified phases are present. In addition, the phase recommendation engine 128 generates phase-specific entry and exit criteria, which are stored in association with each relevant phase node for later use by scheduling and assessment functions within the platform 100.

The cross-layer proposition mapping engine 130 provides an additional dimension of structural organization. This engine 130 analyzes the nodes within the journey data structure and determines how the transformation journey spans across different organizational aspects, such as the enterprise layer, function layer, and foundational technology layer. It creates edges between nodes associated with these layers and nodes representing tasks, outcomes, or deliverables that relate to those organizational aspects. These cross-layer mappings ensure that the structure accurately represents the multi-layer nature of enterprise transformation and enables the platform 100 to propagate changes across organizational layers when any single element of the journey is modified.

The system 100 also maintains a persistent enabler library 116, stored in non-transitory storage 108 and referenced by multiple engines. The enabler library 116 contains a plurality of enablers 114, each associated with multi-dimensional metadata describing properties such as applicable phase, transformation objective, industry sector, technology platform, and organizational aspect. The enabler selection engine 132 evaluates this metadata in conjunction with client data 110 and the current state of the journey data structure to compute relevance scores for each enabler. Enablers whose relevance scores exceed a threshold are selected, and corresponding enabler nodes are inserted into the journey data structure along with edges indicating connections to tasks, outcomes, or phases that the selected enablers support. As engagements are completed, the enabler selection engine 132 updates enabler metadata based on usage and observed value realization, thereby refining enabler relevance predictions over time.

In parallel with journey construction, the system 100 processes content from the content repositories 122 using a unified content schema. This schema specifies fields for content objects including content type, journey phase, proposition, outcome, task identifier, and enabler identifier. The system 100 normalizes heterogeneous content objects, ranging from human-authored documents to structured tables, into normalized content records conforming to this schema. These normalized records are then stored in the multi-modal search index 118, a retrieval structure that indexes both structured and unstructured content. The search index 118 associates normalized records with corresponding nodes in the journey data structure based on matching schema fields. The search index 118 thus enables context-aware retrieval such that, when the system 100 receives a search query alongside a journey context that identifies a node in the journey graph, the system 100 returns ranked search results representing content records associated with nodes related to the identified node.

A critical output-generating component is the work breakdown structure (WBS) generator 134, which traverses the journey data structure to produce a structured WBS table. As shown in FIG. 1, the WBS generator 134 reads nodes representing tasks and extracts attributes including phase, organizational aspect, resource role, and timing information. It organizes this information into rows and columns of a WBS table structure, which is then exported in machine-readable format such as CSV or XLSX. The exported WBS is integrated into an export package 136 that also includes a journey overview generated from the journey data structure. The export package 136 is delivered to the user interface 126 for practitioner consumption and is also made available to downstream client-delivery systems.

The user interface 126 depicted in FIG. 1 provides the primary interaction surface through which practitioners access system outputs and introduce user modifications. The system allows users to navigate the journey via an interactive journey navigator that visualizes journey segments corresponding to nodes in the journey data structure. When a user interacts with this visualization, the system 100 retrieves content from the multi-modal search index 118, displays associated enablers and content objects, and enables the user to select or deselect enablers or modify journey elements. User modifications are then passed back into the engagement platform 100, where the journey generation engine 124 revises the journey data structure, the phase recommendation engine 128 re-evaluates readiness scores, and the WBS generator 134 regenerates the WBS as necessary.

Finally, the system 100 collects feedback data during practitioner use, including user-approved modifications and actual engagement outcomes. These data are stored in non-transitory storage 108 and used to retrain the AI model underpinning the journey generation engine 124 and the phase recommendation engine 128. The retraining process refines the model's ability to predict phase readiness, select enablers, and construct structurally coherent journeys aligned with client needs. Through this continuous learning, the system 100 evolves over time, improving the quality and accuracy of the transformation journeys it constructs.

In this integrated architecture, FIG. 1 shows how each element, including the processors, memory, engines, indices, libraries, and interfaces, collectively forms a dynamic, adaptive system that ingests client and content data, synthesizes them into a structured transformation model, and outputs actionable deliverables such as the WBS table and journey export package while constantly refining its internal logic through feedback.

### Process Flow

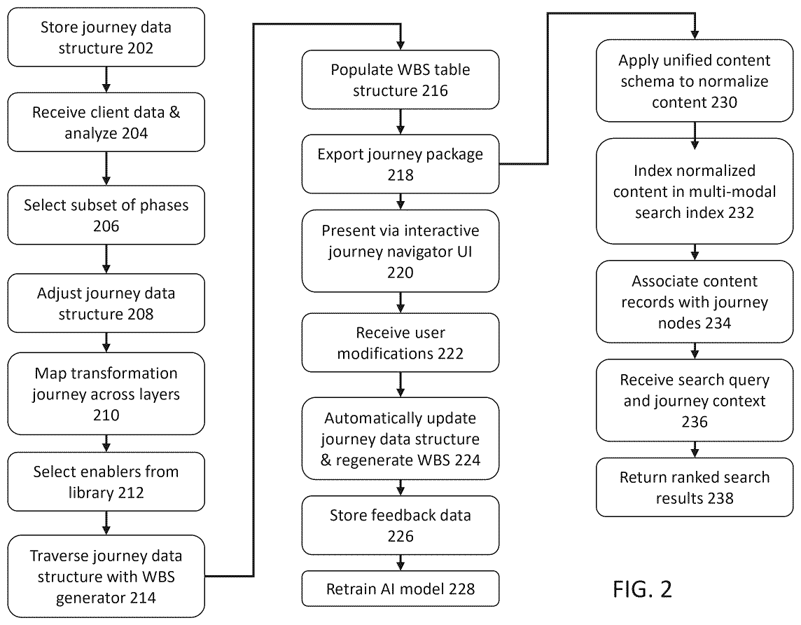

FIG. 2 illustrates a method-level flow of operations performed by the transformation-planning platform and implemented by the system architecture of FIG. 1. Together, FIG. 1 and FIG. 2 depict how the processors, memory, engines, indices, and libraries cooperate to ingest client and content data, configure and refine a journey data structure, generate a work breakdown structure (WBS), support context-aware search, and continuously improve recommendations through feedback and retraining of the AI model.

The flow begins with the system storing 202 a journey data structure in non-transitory memory. In the FIG. 1 architecture, this journey data structure resides in storage 104, which may be backed by non-transitory storage 108 and accessed via volatile memory 106 by the processor or processors 102. The journey data structure includes a plurality of nodes and edges interconnecting the nodes to represent elements of a transformation journey and dependencies among those elements. This initial storage operation either initializes an empty or template journey graph or retrieves a prior journey graph associated with an ongoing engagement. The journey generation engine 110 executing on processor 102 is the primary component responsible for instantiating and maintaining this data structure; its output at this stage is a graph that can be populated and refined as subsequent steps in the flowchart are executed.

Once the journey data structure is available in memory, the system proceeds to receive 204 client data and analyze it. Client data 110 and engagement data 112 arrive from the various data sources 120 of FIG. 1, which includes client data and engagement data feeds, and are buffered in volatile memory 106. The journey generation engine 110 then invokes an artificial intelligence model and/or a rules engine, implemented as software modules stored in non-transitory storage 108 and executed by processor 102, to process this client data 110. During this analysis step, the engine 110 evaluates the client's transformation triggers, strategic objectives, relevant industry sector, target platforms, and other engagement-specific parameters. The output of this analysis is a set of recommendations regarding which transformation phases, outcomes, and high-level tasks should be included in the transformation journey, which the engine uses in the next step of the flow.

The method then selects 206 a subset of transformation phases from a predefined set comprising strategize, architect, orchestrate, mobilize, deliver, and run. This selection operation is carried out primarily by the phase recommendation engine 128 alongside the journey generation engine 124 and cross-layer proposition mapping engine 130. The phase recommendation engine 128 computes readiness scores for each phase based on the analyzed client data and, in some embodiments, historical transformation-journey instances encoded in prior journey data structures stored in storage 104. It identifies which phases meet or exceed a readiness threshold and outputs a subset of phases to the journey generation engine. At this point, the journey generation engine 124 uses these phase selections as input to adjust 208 the journey data structure, ensuring that only transformation-journey elements associated with readiness-qualified phases are present in the graph. The phase recommendation engine 128 also generates phase-specific entry and exit criteria, which the journey generation engine 124 records in association with nodes corresponding to the selected phases.

After phase selection, the method explicitly adjusts the journey data structure. This step is implemented in FIG. 1 by journey generation engine 124 operating on the graph stored in storage 104. The engine 124 may add, remove, or reconnect nodes and edges to reflect the selected phases and to create a coherent path through the transformation journey. For example, if a phase is excluded as insufficiently ready, the engine removes nodes and edges that would otherwise represent tasks or outcomes unique to that phase, while preserving graph consistency so that dependencies and ordering constraints remain valid. Conversely, if new phases are added, the engine 124 creates the corresponding nodes and edges and links them into the existing sequence of transformation activities. The output is an updated journey data structure that accurately reflects the configured phase set and is ready for further refinement in subsequent steps.

The next operation in FIG. 2 is to map 210 the transformation journey across layers, which is accomplished by the cross-layer proposition mapping engine 130. During this step, the mapping engine 130 analyzes the revised journey data structure and determines how journey elements correspond to different organizational aspects, such as enterprise-level transformation, functional transformation, and foundational technology changes. It creates edges between nodes representing these organizational aspects, e.g., layer nodes representing enterprise, function, and foundational layers, and nodes representing transformation-journey elements such as tasks, outcomes, or deliverables. These cross-layer edges are written back into the journey data structure in storage 104, enriching the graph with relationships that capture the multi-layer nature of the engagement. The output of this mapping step is a journey data structure whose nodes and edges collectively encode both phase-based flow and layer-based structure.

With the layered journey representation in place, the method advances to selecting 212 enablers from the enabler library. FIG. 1 shows an enabler library 116 stored in non-transitory storage 108, containing enablers and their associated metadata 114, and an enabler selection engine 132 that operates on this library 116. The enabler selection engine 132 reads the current state of the journey data structure and the client data, then compares this information to multi-dimensional metadata associated with each enabler, including journey phase, transformation objective, industry sector, technology platform, and organizational aspect. It computes relevance scores for each enabler and selects those whose scores surpass an enabler-selection threshold. The engine 132 then associates corresponding nodes in the journey data structure with the selected enablers by creating or updating enabler nodes and edges linking those nodes to tasks, outcomes, or phases. The result is a journey data structure augmented with enabler-specific information that directly supports implementation of the transformation journey.

The flow then calls for traversing 214 the journey data structure with the WBS generator 134 and populating a WBS table structure. The WBS generator 134 accesses the journey data structure in storage 104 via processor 102 and volatile memory 106. The WBS generator 214 identifies nodes representing tasks or task-related elements and reads associated attributes from the graph, including phase affiliation, organizational aspect, and any scheduling or resource implications derived from dependency edges. It then constructs 216 a WBS table structure in memory, assigning a row to each task-related node and populating columns for phase, organizational aspect, resource role, and timing fields, as recited in the claims. When the WBS table is fully populated, the WBS generator 134 passes it to an export component that writes the table to non-transitory storage 108 as a machine-readable file and marks it as part of an export package 136 for delivery to the user interface 126 of FIG. 1.

The subsequent step in FIG. 2 is to export 218 the journey package and present 220 the journey via an interactive journey navigator user interface. At this stage, the engagement platform aggregates outputs produced by the journey generation engine 124, cross-layer mapping engine 130, enabler selection engine 132, WBS generator 134, and multi-modal search index 118. The journey package includes at least a representation of the journey data structure and the populated WBS table structure, and may also include a human-readable journey overview document describing phases, phase entry and exit criteria, and key enablers. This package is made available to a user interface 126 that renders the transformation journey as a series of segments organized by phase and outcome. The interactive journey navigator uses the journey data structure to determine which nodes and edges to display, and when the user focuses on a particular task or outcome, the interface can issue search queries to the multi-modal search index to retrieve associated content and enablers for display.

After the journey package is presented, the system enters a continuous improvement loop involving feedback and retraining of the AI model. FIG. 2 depicts steps for receiving 222 user modifications, updating 224 the journey data structure and regenerating the WBS, storing 226 feedback data and retraining 228 the AI model. As users interact with the interactive journey navigator, they may modify the journey by adding or removing tasks, changing dependencies, or altering enabler selections. These modifications, along with eventual engagement outcomes, are stored as feedback data in non-transitory storage 108 in association with the journey data structure. Periodically, the system invokes a retraining mode in which the AI model used by the journey generation engine 124 and phase recommendation engine 128 is updated using this feedback and historical journey graphs, thereby improving future recommendations regarding phase selection, mapping, and enabler selection. FIG. 2 shows receiving user modifications and automatically updating the journey data structure and regenerating the WBS. These steps close the loop between user interaction and system configuration. When the user modifies the journey via the interactive navigator—by, for example, re-sequencing tasks or changing enabler assignments—the user interface communicates these changes back to the engagement platform. The journey generation engine updates the journey data structure in storage 104, preserving graph consistency as recited in the system claims. The cross-layer mapping engine may adjust cross-layer edges, the phase recommendation engine may re-evaluate readiness scores and entry/exit criteria, and the enabler selection engine may recompute relevance scores to ensure that the modified graph still represents an optimal journey. Once the journey data structure has been updated, the WBS generator re-traverses the graph, populates a new WBS table structure that reflects the modifications, and outputs an updated WBS file as part of a refreshed export package. The updated WBS and journey structure are immediately reflected in the user interface, while the modifications and resulting outcomes are recorded as feedback data for use in subsequent retraining cycles of the AI model.

FIG. 2 then shifts focus to the content-normalization and search workflow, which may also be concurrent to the modification and regeneration path just described. The method applies 230 the unified content schema to normalize content from the content repositories, indexes 232 the normalized content in the multi-modal search index 118, associates 234 content records with journey nodes, receives 236 a search query and journey context, and returns 238 ranked search results. In this portion of the flow, content from FIG. 1's content repositories 122 is retrieved into volatile memory 106 and passed through a normalization component that uses the unified content schema to create normalized content records with fields such as content type, journey phase, proposition, outcome, task identifier, and enabler identifier. The system inserts these records into the multi-modal search index 118, which is stored in non-transitory storage 108 and accessed via processor 102. For each normalized record, the system identifies related nodes in the journey data structure using the phase, outcome, task, or enabler identifiers, and creates associations so that the search index 118 can later be queried in a journey-aware manner. When the user issues a search query through the user interface 126, together with a journey context that identifies at least one node in the journey data structure, the search index 118 returns ranked search results comprising normalized content records associated with nodes related to the identified node. These results are presented in the interface 126 alongside the corresponding journey segment, enabling practitioners to browse and select contextually relevant content and enablers.

In this way, FIG. 2's flowchart, when read together with FIG. 1's architecture, portrays a tightly integrated, iterative process in which the journey generation engine, cross-layer proposition mapping engine, phase recommendation engine, enabler selection engine, multi-modal search index, WBS generator, and user interface cooperate at each step. Data flows from client and content sources into the engines and journey data structure, through analysis, selection, mapping, and search, and back out as exportable artifacts and interactive visualizations, while the system continuously refines itself using stored feedback and model retraining.

### Computer Device

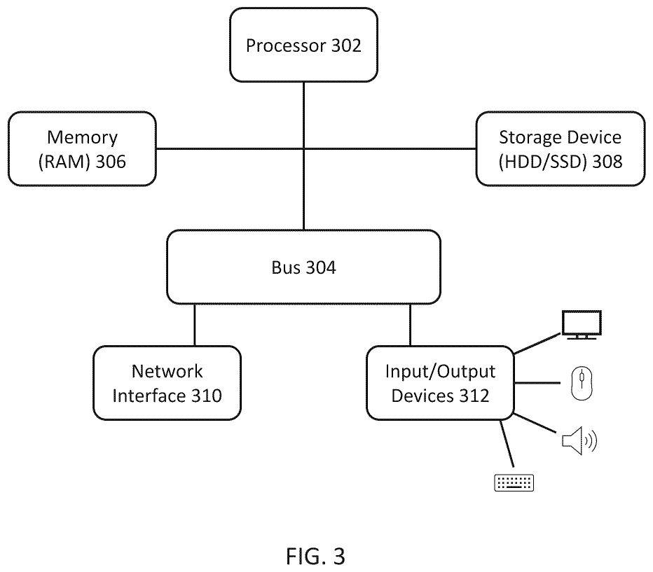

FIG. 3 illustrates an exemplary computer hardware device and suitable networked computing environment for implementing the systems and executing the computer-implemented methods described in this application. The claimed invention is realized through the coordinated operation of one or more hardware processors and a computer memory, executing the stored instructions that perform journey construction, phase selection, cross-layer mapping, enabler identification, content normalization, search indexing, and WBS generation.

At the core of the system are one or more processors (CPU) 302, which fetch and execute instructions that implement each of the functional engines including the journey generation engine 124, the phase recommendation engine 128, the cross-layer proposition mapping engine 130, the enabler selection engine 132, and the WBS generator 134. These processors are responsible for constructing the journey data structure from client data 110, computing phase readiness scores using AI or rules-based logic, generating cross-layer mappings between transformation-journey elements and organizational aspects, evaluating enabler relevance based on multi-dimensional metadata, normalizing content objects under the unified content schema, performing searches within the multi-modal search index 118, and traversing the journey graph to generate the machine-readable WBS table. Each of these operations consists of a sequence of stored instructions that the processors execute in response to system inputs and user interactions, thereby physically realizing the claimed system's functionality.

The processors 302 exchange data with a memory (RAM) 306 subsystem via a system and data bus 304, as shown in FIG. 3. The memory 306 provides high-speed, volatile storage used during the runtime execution of the engines that manipulate the journey data structure. The memory 306 stores executable instructions and maintains key data structures for low-latency access. During operation, the memory 306 holds the active instance of the journey data structure, including a graph of nodes and edges representing phases, sub-phases, outcomes, deliverables, tasks, organizational layers, and enablers. It also stores intermediate representations created by the engines, such as calculated readiness scores, cross-layer edge relationships, enabler relevance scores, normalized content objects prepared for indexing, and the populated WBS table prior to export.

Because the platform's operations involve continuous updates to the journey data structure and active traversal of node relationships, the memory 306 plays a central role in enabling real-time modification, recomputation, and redisplay of journey artifacts.

For long-term durability, the system includes one or more storage devices (HDD/SSD) 308, which provide non-transitory computer-readable media for persisting the foundational data, content, and models used by the platform. The storage devices 308 maintain the complete enabler library 116, including metadata 114 indicating the transformation objectives, applicable phases, industry sectors, technology platforms, and organizational aspects associated with each enabler. They also store previously generated journey data structures for reuse across engagements, historical WBS tables, normalized content objects indexed by the multi-modal search index 118, and learned parameters or rules used by the phase recommendation engine 128. The instructions that implement each of the engines are also stored in these devices and loaded into memory 306 as needed to execute the claimed methods.

The system further includes a network interface 310, a hardware component that provides connectivity to external systems, cloud repositories, enterprise content systems, and client devices. This interface is the means by which client data enters the platform whether through practitioner input, uploaded assessment results, questionnaire responses, or integration with external enterprise systems. It also enables retrieval of structured and unstructured content from content repositories, which are later normalized under the unified content schema and indexed in the multi-modal search index. Additionally, the network interface 310 supports delivery of the export package 136 that includes the machine-readable WBS and journey overview, making these outputs available to remote user interfaces, downstream project-management tools, or client-delivery systems.

Input/output devices 312, including displays, keyboards, pointing devices, and touch interfaces, provide the human-facing interaction layer. Through these I/O devices 312, practitioners interact with the interactive journey navigator to examine transformation-journey elements, view phase-level recommendations, inspect enabler associations, select content retrieved by the multi-modal search index, and apply modifications to the journey data structure. These devices also render the exported WBS tables, the journey overview, and diagnostic feedback produced by the engines operating within the system.

Although FIG. 3 depicts a single hardware instance, the systems and methods described can also be deployed across multiple networked computing devices in a distributed environment. In such deployments, the journey data structure, the normalized content store, the enabler library, and the search index may be partitioned or replicated across nodes; engine computations such as phase-readiness scoring, cross-layer mapping, enabler selection, and WBS generation may be distributed across processors in multiple machines; and secure network interfaces provide the communication paths through which these distributed components synchronize state, share content, and deliver user-facing outputs. All data transmitted between such nodes, including client data, normalized content records, and WBS results, are transmitted as electronic signals over secure communication channels.

Through this hardware and networked environment, the system depicted in FIG. 3 provides the physical substrate that executes every claimed feature of the invention. The processors, memory, storage, bus, network interface, and I/O devices jointly carry out the construction, manipulation, traversal, and export of the journey data structure and its associated artifacts, thereby implementing the computer-implemented methods and system operations recited in the claims.

The scope of the invention is not limited to the specific embodiments described, but rather is defined by the claims and their equivalents.

1. A computer-implemented system for configuring a transformation-planning platform for consulting engagements, the system comprising:
one or more processors; and
a non-transitory memory storing instructions that, when executed by the one or more processors, cause the system to implement:
a journey data structure stored in the memory and comprising a plurality of nodes and edges interconnecting the nodes to represent elements of a transformation journey and dependencies among the elements;
a journey generation engine configured to analyze client data using an artificial intelligence (AI) model and/or a rules engine and to generate graph-mutation instructions that cause creation, deletion, or re-connection of nodes and edges in the journey data structure stored in the memory to construct an initial transformation journey;
a cross-layer proposition mapping engine configured to create edges in the journey data structure between nodes representing different organizational aspects to represent cross-layer relationships for the transformation journey;
a phase recommendation engine configured to compute, from the client data, readiness scores for respective transformation phases of a predefined phase set including strategize, architect, orchestrate, mobilize, deliver, and run, and, responsive to the readiness scores, to selective remove or suppress phase-associated nodes and edges from the journey data structure for phases whose readiness scores fail to satisfy a threshold and to store phase-specific entry and exit criteria in association with remaining phase nodes;
an enabler library comprising a plurality of enablers, each enabler associated with multi-dimensional metadata including at least a journey phase, a transformation objective, an industry sector, a technology platform, and an organizational aspect;
an enabler selection engine configured to compute, for each enabler, a relevance score based on the multi-dimensional metadata, the client data, and a current state of the journey data structure, and to insert corresponding enabler nodes and dependency edges into the journey data structure when the relevance score satisfies an enabler-selection threshold;
a unified content schema defining fields for content objects including at least content type, journey phase, proposition, outcome, task identifier, and enabler identifier;
a multi-modal search index that stores the content objects normalized to the unified content schema and associates the content objects with nodes in the journey data structure; and
a work breakdown structure (WBS) generator configured to traverse the journey data structure by iterating over task-associated nodes and dependency edges to generate a WBS table structure having rows corresponding to respective nodes representing tasks and columns including at least phase, organizational aspect, resource role, and timing fields, and to output the WBS table structure in a machine-readable format.

2. The system of claim 1, wherein the nodes of the journey data structure include:
phase nodes representing respective transformation phases;
sub-phase nodes representing respective transformation sub-phases;
outcome nodes representing respective target outcomes;
deliverable nodes representing deliverables supporting the outcomes;
task nodes representing tasks that implement the deliverables;
layer nodes representing organizational layers including at least an enterprise layer, a function layer, and a foundational technology layer; and
enabler nodes representing respective ones of the enablers in the enabler library.

3. The system of claim 2, wherein the edges in the journey data structure encode at least:
dependencies among the task nodes;
associations between the task nodes and corresponding outcome nodes and deliverable nodes; and
cross-layer mappings between the layer nodes and one or more of the phase nodes, sub-phase nodes, outcome nodes, deliverable nodes, task nodes, and enabler nodes.

4. The system of claim 1, wherein the journey generation engine is further configured to update the journey data structure responsive to changes in the client data by adding, removing, or re-connecting at least some of the nodes and edges while preserving graph consistency by enforcing referential integrity between dependent nodes and edges.

5. The system of claim 4, wherein the journey generation engine is configured to store, for each consulting engagement, a corresponding instance of the journey data structure, and to reuse nodes and edges from prior instances when the client data matches prior transformation patterns.

6. The system of claim 1, wherein the phase recommendation engine is configured to derive the readiness scores using a machine-learning model trained on historical transformation-journey instances encoded as graph structures stored in non-transitory memory.

7. The system of claim 6, wherein the phase recommendation engine is further configured to adjust the readiness scores in real time based on user feedback indicating progress or delays in specific phases, and to update the phase entry and exit criteria stored for corresponding phase nodes in the journey data structure.

8. The system of claim 1, wherein the enabler selection engine is further configured to:
compute, the relevance score for each enabler based at least in part on the multi-dimensional metadata, the client data, and the current state of the journey data structure.

9. The system of claim 8, wherein the enabler selection engine is further configured to update the multi-dimensional metadata for respective enablers based on recorded usage and value-realization metrics from completed transformation journeys as represented in journey data structures for prior engagements.

10. The system of claim 1, wherein the multi-modal search index is configured to:
index both structured artifacts including WBS table structures and unstructured artifacts including presentations, briefs, and journey guides; and
rank search results for a query based on a transformation-journey context including at least one of a selected phase, outcome, task, or enabler represented in the journey data structure.

11. A computer-implemented method of configuring a transformation-planning platform for consulting engagements, the method comprising:
storing, in a non-transitory memory, a journey data structure comprising a plurality of nodes and edges interconnecting the nodes to represent elements of a transformation journey and dependencies among the elements;
receiving client data via a network interface;
analyzing the client data using an artificial intelligence (AI) model and/or a rules engine to compute readiness scores for transformation phases from a predefined set including strategize, architect, orchestrate, mobilize, deliver, and run;
modifying the journey data structure by removing or suppressing nodes and edges associated with transformation phases whose readiness scores fail to satisfy a threshold entry and exit criteria in association with remaining phase nodes;
mapping the transformation journey across at least an enterprise layer, a function layer, and a foundational technology layer by creating edges in the journey data structure between nodes representing organizational aspects and nodes representing transformation-journey elements;
computing relevance scores for enablers by comparing multi-dimensional metadata associated with each enabler with the client data and a current state of the journey data structure, and inserting enabler-associated nodes and edges into the journey data structure for enablers whose relevance scores satisfy an enabler-selection threshold;
traversing the journey data structure to generate a WBS table structure having rows representing task-associated nodes and columns representing at least phase, organizational aspect, resource role, and timing fields; and
exporting a journey package comprising at least a representation of the journey data structure and the populated WBS table structure.

12. The method of claim 11, further comprising:
presenting the transformation journey encoded in the journey data structure to a user via an interactive journey navigator user interface that visually arranges journey elements according to phase and outcome.

13. The method of claim 12, further comprising:
receiving, via the user interface, a modification to at least one node or edge of the journey data structure;
automatically updating connected nodes and edges in the journey data structure; and
regenerating the WBS table structure to reflect the modification.

14. The method of claim 11, further comprising:
applying a unified content schema to normalize heterogeneous content objects from a plurality of repositories into normalized content records;
indexing the normalized content records in a multi-modal search index; and
associating the normalized content records with nodes in the journey data structure.

15. The method of claim 14, further comprising:
receiving a search query together with a transformation-journey context identifying at least one node in the journey data structure; and
returning ranked search results from the multi-modal search index including normalized content records associated with nodes related to the identified node.

16. A non-transitory computer-readable storage medium storing instructions that, when executed by one or more processors of a consulting-engagement platform, cause the platform to perform operations comprising:
ingesting client data and transformation-journey configuration data;
maintaining, in a memory, a journey data structure comprising a plurality of nodes and edges representing a current transformation journey and dependencies among elements of the current transformation journey;
applying a unified content schema to normalize heterogeneous content objects obtained from multiple repositories into normalized content records including at least fields for content type, journey phase, proposition, outcome, task identifier, and enabler identifier;
building and maintaining a multi-modal search index over the normalized content records;
associating respective normalized content records with nodes in the journey data structure by storing node identifiers in indexed schema fields;
receiving a search query and a transformation-journey context identifying at least one node in the journey data structure; and
returning ranked search results from the multi-modal search index including normalized content records associated with nodes related to the identified node.

17. The non-transitory computer-readable storage medium of claim 16, wherein the instructions further cause the platform to:
responsive to selection of one or more enablers identified in the ranked search results, create or update corresponding nodes and edges in the journey data structure; and
regenerate a WBS table structure by traversing the journey data structure.

18. The non-transitory computer-readable storage medium of claim 16, wherein the instructions further cause the platform to render an interactive journey navigator user interface that:
displays the transformation journey as a plurality of segments organized at least by phase and outcome based on the journey data structure; and
provides, for each displayed task-related node, a selectable indication of one or more associated enablers and content objects drawn from the multi-modal search index.

19. The non-transitory computer-readable storage medium of claim 18, wherein the instructions further cause the platform to:
expand or collapse detail for respective segments of the transformation journey by dynamically revealing or hiding nodes representing sub-phases, outcomes, deliverables, and tasks in the journey data structure.

20. The non-transitory computer-readable storage medium of claim 16, wherein the instructions further cause the platform to generate a journey export package including:
a file containing the WBS table structure in a machine-readable format;
a human-readable journey overview document generated from the journey data structure; and
one or more collections of links or references to enablers and associated normalized content records grouped by at least journey phase and proposition.
